(19) United States
(12) Patent Application Publication
(10) Pub. No.: US 2013/0101958 A1
(43) Pub. Date: Apr. 25, 2013

(54) APPARATUS FOR MOVING TOOLS USED IN SURGERY

(71) Applicant: Philippe Garcia, Bussieres (FR)

(72) Inventor: Philippe Garcia, Bussieres (FR)

(73) Assignee: MICRO MEGA INTERNATIONAL MANUFACTURES, Besancon (FR)

(21) Appl. No.: 13/520,945

(22) PCT Filed: Jan. 18, 2011
(86) PCT No.: PCT/FR2011/050080

§ 371 Date: Jul. 6, 2012

(30) Foreign Application Priority Data
Jan. 19, 2010 (FR) 1050315

(51) Int. Cl. A61C 1/02; A61C 1/00

(52) U.S. Cl. CPC A61C 1/02; A61C 1/0007
USPC 433/122; 433/131

(57) ABSTRACT

A novel apparatus is provided for moving tools used in surgery, in particular in dental surgery. The apparatus includes a head into which a tool is attached and a shaft onto which the head is attached, characterized in that said apparatus also includes a means for transmitting the movement of a motor to the tool, the transmission means including a first transmission axis, for transmitting a first movement at a first frequency, and a second transmission axis, for transmitting a second movement at a second frequency, the first frequency being different from the second frequency.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to an apparatus for driving the movement of tools used in surgery, in particular in dental surgery, said apparatus being of the type composed of a head, in which a tool is fixed, of a handle, on which the head is fixed, and of means for transmitting movement between a motor and the tool. Such apparatuses are commonly referred to as a straight or contra-angle handpiece, depending on their general external form.

2. Description of Related Art Including Information Disclosed Under 37 CFR 1.97 and 37 CFR 1.98.

Such apparatuses are used in particular in dental surgery, especially for endodontic treatment. In order to clean and ream the root canals, a dentist uses endodontic tools or instruments commonly called root canal instruments. In the early days of endodontic dentistry, these instruments were used manually, and the rotation and/or reciprocating movements of the instrument were produced by the fingers of the dentist.

Gradually, technical developments in dental handpieces allowed this difficult manual work to be mechanized, with different solutions for movement being proposed.

Contra-angles with alternating rotary movements first appeared, then alternating rotation movements combined with axial reciprocating movements of the root canal instrument, the two movements having the same frequency.

In parallel with this, vibratory handpieces also appeared, and also handpieces conferring an axial reciprocating movement on the root canal instrument.

More recently, the nickel-titanium used to manufacture root canal instruments has made it possible to obtain instruments having better fatigue strength and, consequently, has allowed the instruments to be driven in continuous rotation while limiting the risks of rupture caused by fatigue.

A number of new root canal instruments having a very high fatigue strength, since they are also made of nickel-titanium, are designed to function with a rapid axial reciprocating movement of the order of 3000 to 5000 strokes per minute for a travel of approximately 0.4 mm.

### BRIEF SUMMARY OF THE INVENTION

It is an object of the invention to further improve the efficacy of these instruments.

To this end, the invention proposes a novel apparatus, still in line with an apparatus as described above, characterized in that it comprises means for transmitting movement from a motor to the tool, the transmission means comprising a first transmission shaft, for transmitting a first movement at a first frequency, and a second transmission shaft, for transmitting a second movement at a second frequency, the first frequency being different from the second frequency.

The first movement is, for example, a reciprocating translational movement, and the second movement is, for example, a rotation movement.

Tests have shown that the efficacy of the tool is improved if the frequencies of the movements are different. The improvement is particularly marked if the ratio between the two frequencies is substantial, for example in a ratio of 20 to 120. It will be remembered that the frequency of a periodic movement is the measure of the number of times the periodic phenomenon is reproduced per unit of time. Thus, by way of example, a rapid reciprocating frequency of the order of 3000 to 6000 strokes per minute, associated with a slow frequency of rotation of the order of 50 to 150 revolutions per minute, gives good results.

For implementation of the invention, the transmission means can comprise a first shaft for transmitting the first movement and a second shaft for transmitting the second movement, which shafts are partially or totally coaxial. The apparatus thus obtained is more compact.

According to one variant, the apparatus is designed for a standard tool. For this purpose, a bushing holds and drives the movement of the tool in the head of the apparatus. Moreover, the first drive shaft comprises, at one end toward the head of the apparatus, an eccentric crank pin designed to cooperate with a groove of the bushing, such that a rotation movement of the first drive shaft generates the alternating reciprocating movement of the bushing. The apparatus can thus be used with all the tools complying with ISO 1797-1. The crank pin is eccentric by 0.05 to 0.4 mm, for example, thus permitting a reciprocating movement of the tool with an amplitude of 0.1 to 0.8 mm, which is particularly suitable for treating a root canal.

According to another variant, the apparatus is designed to drive in rotation a tool comprising a shank equipped with a gear and with a groove. Such an instrument is described, for example, in the document FR 2 849 767. In the apparatus, the first drive shaft comprises, at one end, an eccentric crank pin designed to cooperate with the groove of the shank of the tool. In this case, the apparatus does not comprise a bushing. The total mass to be moved and the inertia that it generates are lower, which facilitates the movements, especially the alternating translational movement.

To drive the two transmission shafts in rotation at different frequencies, the drive means can be a speed reducer, in which a first shaft of the reducer is used to drive the first transmission shaft in rotation and thus generate the first movement, and in which a second shaft of the reducer is used to drive the second transmission shaft in rotation and thus generate the second movement. The reducer is, for example, a planetary gear train comprising one or more reduction stages.

### BRIEF DESCRIPTION OF THE SEVERAL VIEWS OF THE DRAWINGS

The invention will be better understood, and other features and advantages of the invention will become clear, on reading the following description of illustrative embodiments of apparatuses according to the invention. This example is given as a non-limiting example. The description is to be read in conjunction with the attached drawings, in which:

FIG. 1 is a cross-sectional view of an apparatus according to a first embodiment of the invention,

FIG. 2 is a partial cross-sectional view of an apparatus according to a second embodiment of the invention,

FIG. 3 is a diagram of the kinetics of an apparatus according to the invention, and

FIG. 4 is a detailed view of the head of the apparatus from FIG. 1.

### DETAILED DESCRIPTION OF THE INVENTION

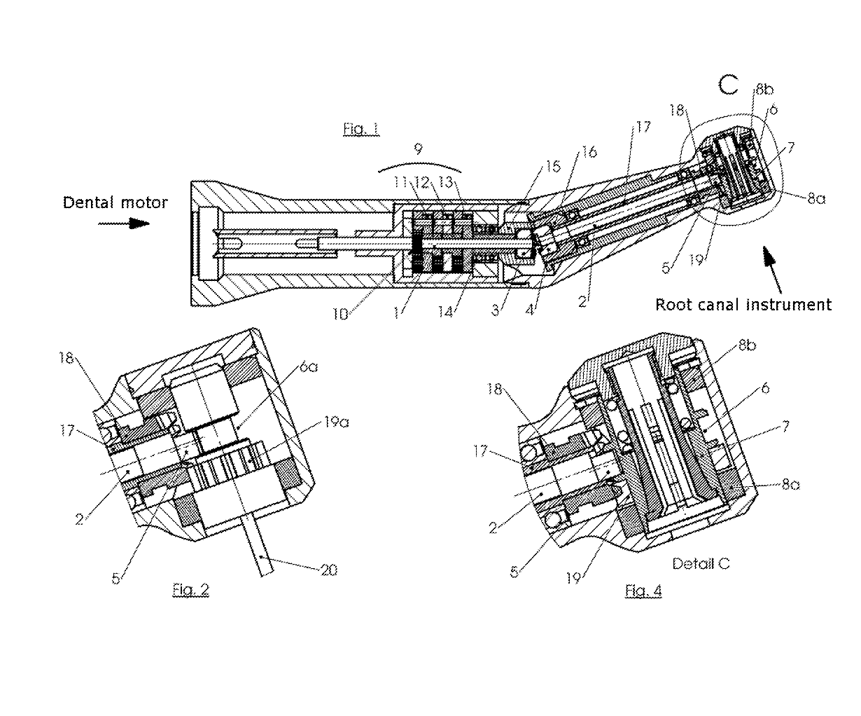

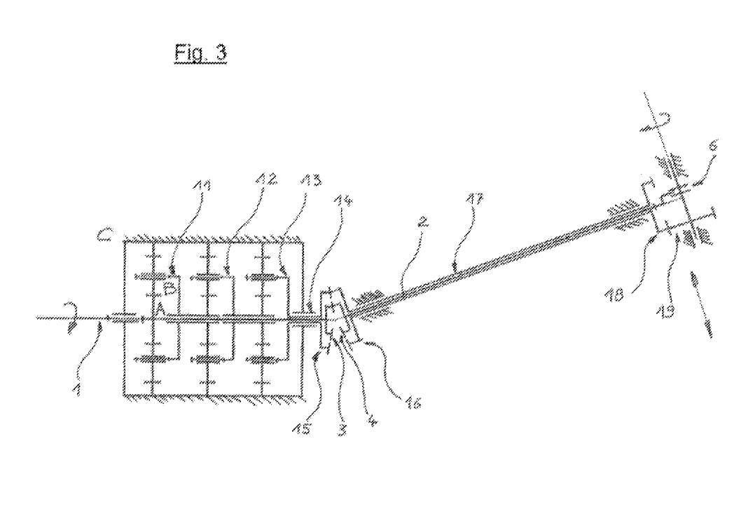

The apparatus shown in FIG. 1 is of the contra-angle type. It comprises a head, in which the tool is held and driven in rotation, and a handle fixed to the head. The inside of the handle accommodates the elements of the transmission means, which are designed as follows.

An input shaft 1 is driven in rotation by a motor (not shown), of which the speed can be regulated in the customary manner, for example between 1000 and 40,000 revolutions per minute.

The first movement is obtained as follows. The shaft 1 drives a first transmission shaft 2 by way of a set of pinions 3 and 4. At its end toward the head of the contra-angle, the shaft 2 is provided with a crank pin 5 which is eccentric with respect to the axis of rotation of the transmission shaft 2. In the example shown, the crank pin is eccentric by 0.2 mm, which makes it possible to obtain a reciprocating movement of the tool with an amplitude of 0.4 mm. The crank pin 5 cooperates with a groove 6 formed on the outside of a bushing 7 containing the system for clamping and retaining the root canal instrument. This bushing 7 is guided in translation and in rotation by the bearings 8a and 8b.

The rotation of the motor, hence of the shaft 1 and then of the shaft 2, will thus cause a reciprocating movement of the bushing 7 and also of the clamping system and the root canal instrument that it contains.

The second movement is obtained as follows. The shaft 1 also drives a planetary reducer (or planetary gear train) with three stages 9 by way of a gear 10. In the reducer, three planet carriers 11, 12 and 13 are guided and turn about the central shaft 1, and the output planet carrier 13 is also guided in a bearing piece 14 formed, for example, by two ball bearings. A pinion 15 is fixed integrally to the end of the output planet carrier 13 and meshes with a pinion 16 that is integral with a second transmission shaft 17 positioned concentrically with respect to the shaft 2. Fixed integrally to the other end of the shaft 17, there is a pinion 18 that meshes with a pinion 19 fixed integrally to the bushing 7.

The rotation of the motor, hence of the shaft 2 and then of the shaft 17, will thus bring about a rotation movement, at reduced speed, of the bushing 7 and also of the clamping system and the root canal instrument that it contains.

In the example shown, the reducer 9 is formed by a fixed crown wheel C provided with an internally toothed gear of 39 teeth, and three reduction stages, of which the input pinions A comprise fifteen teeth and of which the planet pinions B comprise twelve teeth. The link between the shafts 1 and 2 is formed by two pinions 3 and 4 having the same number of teeth. The link between the output planet carrier 13 and the shaft 17 is formed by two pinions 15 and 16 having the same number of teeth. The link between the shaft 17 and the bushing 7 containing the root canal instrument, and its clamping system, is formed by a driving pinion 18 with ten teeth and a driven pinion 19 with fourteen teeth. In these conditions, the speed-reducing ratio between the input shaft 1 and the bushing 7 is equal to:

R=[(15+39)/15]̂3*[14/10]

Thus, when the speed of rotation of the shaft 1 (speed of the motor) is set to 5000 revolutions per minute, the root canal instrument fixed in the head of the contra-angle will turn at 5000/R=76 revolutions per minute, while having an axial reciprocating movement of 5000 strokes per minute for a travel of 0.4 mm.

It will be appreciated that the embodiment in FIG. 1 is given only by way of example and that many variations are conceivable.

For example, the speed-reducing ratio can be adjusted in different ways: the reducer 9 can have other speed-reducing ratios, with more or fewer planetary reduction stages; the number of teeth of the pinions A, B and C could be different for each of the stages of the planetary gear reducer; the pairs of pinions 3 and 4 and/or 15 and 16 can have different numbers of teeth, and therefore speed-reducing ratios different than 1.

The purpose of an apparatus according to the invention is to obtain two movements from one input rotation speed, namely a rotary movement and an alternating linear movement, of which the frequency levels are different, preferably very different.

Likewise, in the example shown, the pairs of pinions 3 and 4 and/or 15 and 16 are indispensable insofar as the apparatus is of the contra-angle type with a bent handle. However, these pairs of pinions could be omitted in the case of a straight handpiece, where the input shaft 1, the output shaft of the planet carrier 13 and the drive shafts 2, 17 have the same axis of rotation.

It should be noted that most of the motors used in dentistry can be adjusted between 1000 and 40,000 revolutions per minute. To use the described contra-angle under the conditions that have been described above, the dentist therefore has to set the speed of the motor to 5000 revolutions per minute, which is inconvenient since, generally, the dentist leaves the motor set at 40,000 revolutions per minute and then trusts the speed-reducing or speed-increasing ratios of the different contra-angles in order to adjust the speed of the tool to the correct value.

Thus, a particularly advantageous configuration of the present invention involves using a motor whose speed is 40,000 revolutions per minute, which avoids the dentist having to modify the speed of the motor. The rotation speed and the reciprocating frequency of the instrument can be similar to the preceding example, by adapting the elements of the reducer and the number of teeth of the different pinions.

To this end, it is possible to use, for example:
a reducer with 4 reduction stages, having:
   a fixed crown wheel C comprising 39 teeth for the first two stages and 41 teeth for the last two stages,
   input pinions A comprising 19 teeth for the first two stages and 9 teeth for the last two stages,
   planet pinions B comprising 10 teeth for the first two stages and 16 teeth for the last two stages,
a pinion 3 with 14 teeth and a pinion 4 with 12 teeth,
a pinion 15 with 20 teeth and a pinion 16 with 24 teeth, and
a pinion 18 with 9 teeth and a pinion 19 with 14 teeth.

If the speed of the shaft 1 is 40,000 revolutions per minute and if the shaft 2 is driven by the output planet carrier of the second stage, the speed of rotation of the shaft 2, that is to say the number of reciprocating strokes applied to the root canal instrument, is equal to:

40,000×(19/(19+39))²×14/12=5007.93

If the speed of the shaft 1 is 40,000 revolutions per minute and if the shaft 17 is driven by the output planet carrier of the fourth stage, the speed of rotation of the bushing 7 and of the root canal instrument is equal to:

40,000×(19/(19+39))²×(9(9+41))²×20/24×9/14=74.51 revolutions per minute.

It will thus be seen that the invention affords many possibilities of obtaining two movements from one input speed of rotation, namely an axial reciprocating movement and a rotary movement, in ranges of speed or frequency that can be very different from each other.

In the examples described above, the axial reciprocating movement is more rapid than the rotary movement, although it should be noted that the same principle also makes it possible to obtain a reciprocating movement slower than the rotation movement. To do so, it suffices to invert the output movement take-offs of the reducer 9.

According to the same concept, it is possible to obtain more than two simultaneous movements, for which it suffices to connect other transmission shafts to other planetary reduction stages of the same reducer. An additional movement could be used, for example, to drive a pump for delivering a fluid to the head of the apparatus or to the working zone of the tool.

FIG. 1 shows an embodiment of the invention particularly designed to drive a tool with a standard shank, held by a conventional clamping system.

FIG. 2 shows an embodiment of the invention particularly designed to drive a tool with a specific shank provided with its own gear 19a and its own groove 6a. Compared to the apparatus of FIG. 1, the apparatus of FIG. 2 does not comprise a bushing or a system for clamping the tool. The pinion 18 drives the pinion 19a of the tool directly, and the crank pin 5 cooperates directly with a groove 6a provided for this purpose on the shank of the tool. Thus, the mass to be driven in motion is limited to the mass of the tool. It is therefore much lighter than that of a system with a standard shank, especially if the specific shank is made of plastic.

1. An apparatus for driving the movement of tools used in surgery, in particular in dental surgery, said apparatus being composed of a head, in which a tool is fixed, and of a handle, on which the head is fixed, characterized in that said apparatus also comprises means for transmitting movement from a motor to the tool, the transmission means comprising a first transmission shaft, for transmitting a first movement at a first frequency, and a second transmission shaft, for transmitting a second movement at a second frequency, the first frequency being different from the second frequency in a ratio of 20 to 120.

2. The apparatus as claimed in claim 1, in which the first movement is an alternating translational movement, and in which the second movement is a rotation movement.

3. The apparatus as claimed in claim 1, in which the first transmission shaft and the second transmission shaft are partially or totally coaxial.

4. The apparatus as claimed in claim 2, in which:
a bushing holds and drives the movement of the tool in the head of the apparatus, and
the first drive shaft comprises, at one end, an eccentric crank pin configured to cooperate with a groove of the bushing, such that a rotation movement of the first drive shaft generates the alternating reciprocating movement of the bushing.

5. The apparatus as claimed in claim 2, configured to drive in rotation a tool comprising a shank equipped with a gear and with a groove, in which the first drive shaft comprises, at one end, an eccentric crank pin configured to cooperate with the groove of the shank of the tool.

6. The apparatus as claimed in claim 1, in which the drive means also comprise a speed reducer, a first shaft of the reducer being used to drive the first transmission shaft in rotation and to generate the first movement, and a second shaft of the reducer being used to drive the second transmission shaft in rotation and to generate the second movement.

7. The apparatus as claimed in claim 6, in which the reducer is a planetary gear train comprising one or more reduction stages.

8. The apparatus as claimed in claim 7, in which:
the first shaft of the reducer is an input shaft or an intermediate shaft of the reducer and/or
the second shaft of the reducer is an intermediate shaft or an output shaft of the reducer.

9. The apparatus as claimed in claim 1, in which the transmission means are also configured to generate more than two movements.
